(19) United States
(12) Patent Application Publication
(10) Pub. No.: US 2025/0211470 A1
(43) Pub. Date: Jun. 26, 2025

(54) METHOD AND SYSTEM FOR PULSE SHAPING OF BASEBAND SIGNALS IN COMMUNICATION NETWORKS USING ELECTROQUASISATIC SIGNALS

(71) Applicant: Quasistatics Inc., West Lafayette, IN (US)

(72) Inventors: Anirudh Roy, Gurugram (IN); Shreyas Sen, West Lafayette, IN (US); Shovan Maity, West Lafayette, IN (US)

(21) Appl. No.: 18/911,470

(22) Filed: Oct. 10, 2024

Related U.S. Application Data
(60) Provisional application No. 63/613,749, filed on Dec. 21, 2023.

(51) Int. Cl. H04L 25/03

(52) U.S. Cl. CPC H04L 25/0384; H04L 25/03847

(57) ABSTRACT

Systems and methods for pulse shaping of baseband signals in a communication network using Electro Quasistatic signal is disclosed. The system up-samples baseband symbols in digital domain for generating an up-sampled baseband symbols. Further, the system pulse shapes the up sampled baseband symbols in the digital domain to generate pulse shaped symbols to be transmitted as a bandlimited waveform based on spectral mask requirements. The system up-converts a frequency of the pulse shaped symbols in digital domain to a desired frequency band for generating a frequency up converted pulse shaped waveform based on a sampling frequency and a symbol rate. The system further generates a reference analog signal (St) by converting the frequency up converted pulse shaped waveform in digital domain to analog domain. Furthermore, the system communicates the generated reference analog signal to a receiver system using a human body.

### CROSS REFERENCE

This Application is based upon and derives the benefit of U.S. Provisional Application No. 63/613,749 filed on Dec. 21, 2023, the contents of which are incorporated herein by reference.

### TECHNICAL FIELD

Embodiments of the present disclosure generally relate to communication systems, and more particularly relates to a method and system for pulse shaping of baseband signals in communication networks using electro quasistatic signals.

### BACKGROUND

Wireless communication has traditionally relied on radio waves due to their advantageous properties, such as the ability to cover large distances and enable non-line-of-sight signaling. Radio wave-based wireless communication is instrumental in various applications, including GPS, voice, and video transmission. However, the radio frequency spectrum is a finite resource, necessitating efficient and optimal bandwidth utilization. To address this, each country's Communication Regulatory Authority allocates specific frequency bands for distinct applications such as Wi-Fi, GSM, and GPS. These authorities also define spectral masks for each band to prevent interference between different communication channels.

To comply with the regulations set by these authorities, transmitters in communication links perform filtering and frequency translation on the baseband signal to align with the spectral mask and the designated frequency band for specific applications. Pulse shaping is a critical filtering process that enables the transmitted signal to meet these spectral requirements. Special classes of filters are typically employed on the transmit side to ensure that the receiver may decode the transmitted symbols without inter-symbol interference (ISI). Although the receiver often uses the same filter as the transmitter-referred to as a matched filter topology—this is not always necessary to achieve ISI-free communication. The combined impulse response or frequency response of the transmitter and receiver filters is termed a Nyquist pulse in the time or frequency domain, respectively, if the system guarantees ISI-free communication.

Low-power wireless communication has been a focal point of research for decades. Wireless communication at low power levels opens new possibilities, such as the Internet of Body (IoB), and enhances existing technologies like Bluetooth and Wi-Fi. One significant advancement in ultra-low-power wireless communication is Human Body Communication (HBC), which utilizes the human body as a communication medium by coupling small, harmless electrical signals to the body. HBC employs Electro Quasistatic (EQS) fields, which are non-radiative, ensuring that the signal remains physically confined to the body. This confinement not only enhances physical security against hacking but also improves energy efficiency per bit of communication.

As the field of HBC is evolving, there lacks systems or techniques for implementing pulse shaping for signals coupled to the human body. The absence of pulse shaping in current implementations leads to transmitted signals that are not band-limited, causing the body to radiate electromagnetic waves at higher harmonics of the carrier. These electromagnetic waves, which may emanate from the body, the HBC transmitter, or the transmitter-body interface, have the potential to violate the limits set by the communication regulatory authorities and could interfere with existing radio wave communication systems. However, unlike antennas designed for radio wave communication systems, the human body is not an effective antenna, resulting in relatively lower emissions. This characteristic somewhat relaxes the requirements for the pulse shape's frequency response in HBC compared to traditional wireless transmitters.

Therefore, there is a need in the art to provide a method and system for pulse shaping of baseband signals in communication networks to address the aforementioned deficiencies in the art.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

An aspect of the present disclosure provides a system for pulse shaping of baseband signals in communication networks using electro quasistatic signals. The system includes an up-sampling module configured to up-sample baseband symbols in digital domain for generating an up-sampled baseband symbols. Further, the system includes a pulse shaping module configured to pulse shape the up-sampled baseband symbols in the digital domain to generate pulse shaped baseband symbols to be transmitted as a bandlimited waveform based on spectral mask requirements. The system further includes a frequency up-conversion module configured to up-convert the frequency of the pulse shaped symbols in digital domain to a desired frequency band for generating a frequency up converted pulse shaped waveform based on a sampling frequency and a symbol rate. The system further includes a digital to analog converter configured to generate a reference analog signal (St) by converting the frequency up converted pulse shaped waveform in digital domain to analog domain. Furthermore, the system includes a communication module configured to communicate the generated reference analog signal to a receiver system via a driver capable of coupling signals to a human body.

Another aspect of the present disclosure includes a method for pulse shaping of baseband symbols into baseband signals for Communication networks using electro quasistatic signals. The method includes up-sampling, by a processor, baseband symbols in digital domain for generating an up-sampled baseband symbols. Further, the method includes pulse shaping, by the processor, the up-sampled baseband symbols in the digital domain to generate pulse shaped baseband symbols to be transmitted as a bandlimited waveform based on spectral mask requirements. Furthermore, the method includes up-converting, by the processor, the frequency of the pulse shaped baseband symbols in digital domain to a desired frequency band for generating a frequency up converted pulse shaped waveform. Additionally, the method includes generating, by a digital to analog converter, a reference analog signal (St) by converting the frequency up converted pulse shaped waveform in digital domain to analog domain. Further, the method includes communicating, by the communication module, the generated reference analog signal to a receiver system via a driver capable of coupling signals to a human body.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF ACCOMPANYING DRAWINGS

The disclosure will be described and explained with additional specificity and detail with the accompanying figures in which:

FIG. 1 illustrates an exemplary block diagram representation of a transmitter side communication system for pulse shaping baseband signals in Human Body Communication (HBC) networks, according to an example embodiment of the present disclosure;

FIG. 2 illustrates an exemplary block diagram representation depicting a detailed view the communication system comprising a plurality of components capable of pulse shaping and up converting baseband signals in Human Body Communication (HBC) networks, according to an example embodiment of the present disclosure;

FIGS. 3A-B illustrates exemplary block diagram representations of a pulse shaping module and a frequency up conversion module, such as those shown in FIG. 2, capable of pulse shaping and up-converting the pulse shaped symbols, according to an example embodiment of the present disclosure;

FIG. 4 illustrates an exemplary timing diagram representation of a convolution window between up-sampled baseband bits and transmitter side pulse shaping module for LUT entry computation for pulse shaping, according to an example embodiment of the present disclosure;

FIG. 5 illustrates an exemplary timing diagram representation of transients of I & Q baseband symbols, I & Q carrier and the output of interpolation, pulse shaping and mixing of I & Q baseband symbols with carrier for QPSK modulation for transmission over baseband channel, according to an example embodiment of the present disclosure;

FIG. 6 illustrates a time domain impulse response of the transmit pulse shape filter and the corresponding receiver's filter's impulse response and the resulting effective Nyquist pulse, according to an example embodiment of the present disclosure;

FIG. 7 illustrates a graphical representation of a Power Spectral Density of transmitter's output with and without pulse shaping, according to an example embodiment of the present disclosure;

FIG. 8 illustrates an exemplary flow chart representation of a method for pulse shaping baseband signals in Human Body Communication (HBC) networks, according to an example embodiment of the present disclosure; and

FIGS. 9A-B illustrates an exemplary LUT storing and generating process, according to an example embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one of a particular element. The terms “a” and “an” may also denote more than one of a particular element. The term “based on” means based at least in part on, the term “based upon” means based at least in part upon, and the term “such as” means such as but not limited to. The term “relevant” means closely connected or appropriate to what is being performed or considered.

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration”. Any embodiment or implementation of the present subject matter described herein as “exemplary” is not necessarily to be construed as preferred or advantageous over other embodiments. The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment”, “in an exemplary embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting. A computer system (standalone, client, or server, or computer-implemented system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or a “subsystem” may also comprise programmable logic or circuitry (as encompassed within a general-purpose processor or other programmable processor) that is temporarily configured by software to perform certain operations. Accordingly, the term “module” or “subsystem” should be understood to encompass a tangible entity, be that an entity that is physically constructed permanently configured (hardwired), or temporarily configured (programmed) to operate in a certain manner and/or to perform certain operations described herein.

Embodiments of the present disclosure describe pulse shaping for communication systems utilizing electro-quasistatic signals to communicate via conductive medium, like the Human Body, for band limiting the transmit signal. This ensures efficient use of channel bandwidth as well as compliance with radiation levels set by relevant regulatory authorities. Receiver impulse responses that ensure ISI free communication for energy efficient receivers are disclosed. A generalized architecture to implement pulse shaping and frequency translation is disclosed for the transmit side. This disclosed architecture ensures low power design at the transmit side. Specific realization of the generalized design is also disclosed for optimum performance.

The field of pulse shaping for wireless communication has been widely explored over decades and many pulse shapes have been identified, each having its own set of pros and cons. Typically, root raised cosine (RRC) filters are used as a pulse shaping filter on a transmit side and the receiver implements the same filter as a matched filter to satisfy the Nyquist ISI free communication criteria. Many other versions of pulse shapes are used for applications with special requirements. In general, radio wave based wireless systems use some variation of raised cosine filters owing to strict spectral masks set by Regulatory Authorities. To integrate a highly energy-efficient communication into mainstream wireless networks and commercial applications, the challenge of pulse shaping transmit pulses for HBC transmitters must be tackled. Since pulse shaping changes the nature of the transmit signal, the receiver must have a filter such that there is no ISI at the receiver's end.

The present system tackles the issue of developing pulse shapes for the transmit side while keeping in mind the limitations posed on receiver's filter by energy costs. Typical radio wave based wireless communication systems utilize complex digital hardware and algorithms that are very power hungry. In order to fully capitalize on the energy efficiency of the HBC link, the receiver design needs to be simple and low power, mixed signal solutions like integrating receivers allow for low power high efficiency designs. This invention focuses on designing pulse shapes that prevent inter symbol interference (ISI) while accommodating constraints on the receiver structures. For the HBC link to be energy efficient, the transmitter must also implement the pulse shape in an efficient manner. This system presents the framework for building a highly energy efficient way to pulse shape for various types of modulation schemes such as for example, but not limited to, BPSK, QPSK, MQAM and the likes. The present system uses simple circuitry such as for example, but not limited to, LUTs, counters, FIFOs, and adders to achieve this task.

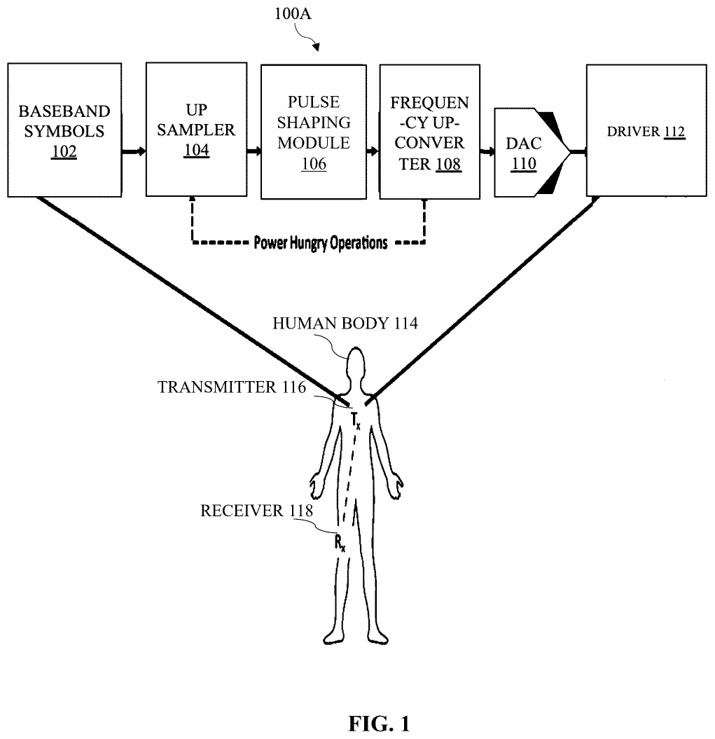

Referring now to the drawings, and more particularly to FIG. 1 through FIG. 9A-B, where similar reference characters denote corresponding features consistently throughout the figures, there are shown preferred embodiments, and these embodiments are described in the context of the following exemplary system and/or method.

FIG. 1 illustrates an exemplary block diagram representation of a transmitter side communication system 100 for pulse shaping baseband signals in Human Body Communication (HBC) networks, according to an example embodiment of the present disclosure. The transmitter side communication system 100 (also referred herein as the system 100) may include, for example, but not limited to, baseband symbols 102, an up sampler 104, a pulse shaping module 106, a frequency up converter 108, a digital to analog converter 110, a driver 112 and a human body 114. The human body 114 may include a transmitter 116 and a receiver 118 as part of the Human Body Communication (HBC) network.

In an example embodiment, the baseband symbols 102 represent original data before any modulation or frequency translation is applied. The baseband symbols 102 are typically derived from digital data, such as bits, which need to be transmitted. In digital communication, the baseband symbols 102 are generated by mapping binary or multilevel data onto a set of signal levels or waveforms that are suited for transmission over a baseband channel. In an example embodiment, the digital data may correspond to any data, such as for example, but not limited to, audio, video, text, or a signal comprising commands or instructions. The data to be transmitted may be communicated between the transmitter 116 and the receiver 118. The baseband symbols 102 are fed as an input to the up sampler 104.

The up-sampler 104 is configured to up-sample baseband symbols in digital domain for generating an up-sampled baseband symbols. The up-sampler 104 converts the original digital signal with a lower sampling rate to a higher sampling rate version. The reasons for up-sampling data to a higher sampling rate includes firstly, to match the sampling/operating rate of components downstream (meaning components located after the stage in question), and secondly, to shift images of the sampled spectra to a higher (farther) frequency for easy removal. This is crucial for ensuring that the transmitted signal meets the spectral requirements and minimizes interference. The LUT is used to store precalculated values for interpolated, pulse shaped, and frequency translated symbols suitable for band limited transmission, leading to a more efficient implementation. Up sampling is a foundational step in the invention that prepares the digital signal for subsequent processing, enabling effective pulse shaping and efficient transmission over the human body communication channel. The up-sampled baseband symbols are fed as an input to the pulse shaping module 106.

In one example embodiment, the up-sampler 104, the pulse shaping module 106 and the frequency up converter 108 may be comprised in a single component. The pulse shaping module 106 is configured to pulse shape the up sampled baseband symbols in the digital domain to generate pulse shaped symbols to be transmitted as a bandlimited waveform based on spectral mask requirements. The LUT houses entries for up-sampled, pulse shaped and frequency translated waveform. The pulse shaping module 106 comprises a filter (not shown). The filter comprises a transmitter side impulse response which is finite. Further, a first derivative of the transmitter side impulse response is continuous at all points. In a specific example, the filter has an impulse response which has a finite length/support and the said impulse response's first derivative is continuous at all points.

The pulse shaping module 106 comprises a filter. The filter is configured to generate the transmitter side impulse response by performing linear operations on sines, sinc and polynomial expressions in either a time domain or a frequency domain. In a specific example, the filter may have an impulse response that is obtained through linear combinations of atleast one of sine, cosine, sinc or polynomial functions involving time as an independent variable. In an alternate embodiment, the filter may also be configured to have its frequency response be composed linear combinations of at least one of sine, cosine, sinc and polynomial functions involving frequency as an independent variable.

The pulse shaping module 106 comprises the filter, the filter is configured to generate pulses by performing convolution of the transmitter side finite impulse response with either an arbitrary pulse of finite length of Ts, or alternatively with a rectangular pulse. The generated pulse upon convolution complies with a Nyquist ISI free communication criteria.

In a specific example, the filter may have an impulse response which when convolved with an arbitrary pulse, having a finite support in time, yields a pulse which obeys the criterion for achieving an ISI free communication link (commonly known as Nyquist ISI free criterion).

The receiver's filter's impulse response when convolved with the impulse response of transmitter's pulse shaping module 106 complies with the Nyquist ISI free criteria.

In an alternate embodiment, where the pulse shaping module 106 may be merged with the frequency up converter 108, all of the above steps may be performed by the single component.

To increase the sampling rate of a signal without adding new information, zero padding is used. This creates multiple copies of the original spectrum. A low-pass filter, known as a pulse shaping filter, is then applied to remove these unwanted copies. The process involves convolving the up sampled data with the filter coefficients. The filter length determines the number of symbols it affects, influencing the output. The concept of producing the combined output of an up-sampler 104 and pulse shaping filter 106 through linear combinations of finite number of precomputed arrays based on input combinations is disclosed.

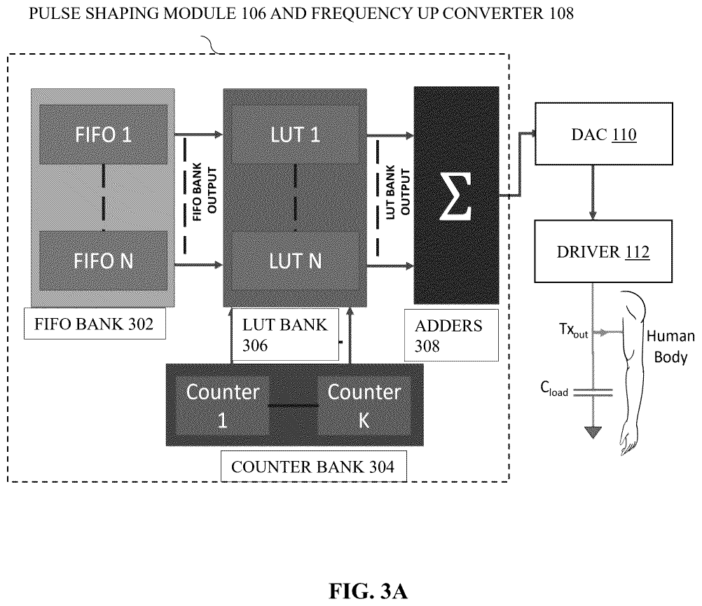

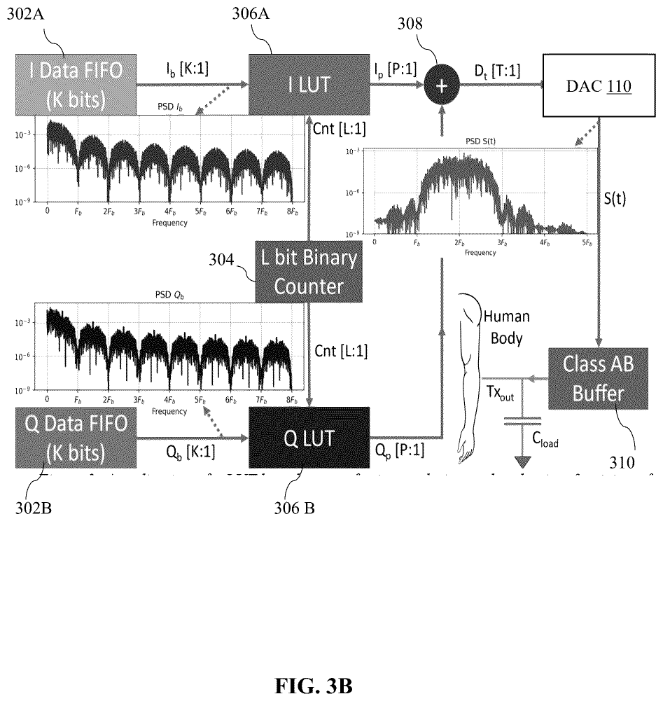

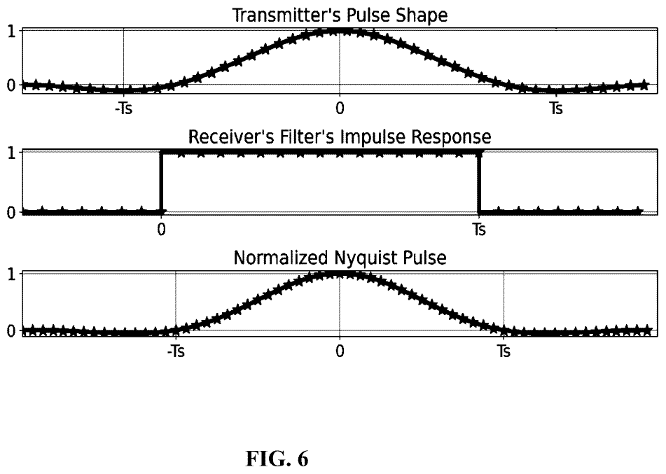

A detailed view of the pulse shaping module 106 is depicted in FIGS. 3A and 3B. In an example embodiment, the impulse response of transmit pulse shaping module (also detailed in FIG. 6) is given by equation (1)

$$P {S}_{T x} ( t ) = \prod ( \frac{t}{{T}_{s}} ) ⊗ \{ \prod ( \frac{t}{{T}_{s}} ) * sin c ( \frac{2 t}{{T}_{s}} ) \} \qquad equation ( 1 )$$

Where Ts is the symbol duration, II (t) is the rectangular function given as equation (2)

$$\prod ( t ) = \{ \begin{matrix}1 & ∀ \vert t \vert < 0.5 \\ 0.5 & ∀ \vert t \vert = 0.5 \\ 0 & ∀ \vert t \vert > 0.5\end{matrix} \qquad equation ( 2 )$$

Where, sinc (t) is the sinc function given by

$$sin c = \frac{sin ( π t )}{π t} \qquad equation ( 3 )$$

Where & & represents the convolution operation.

Further, the frequency up converter 108 may be configured to up-convert a frequency of the pulse shaped baseband symbols in digital domain to a desired frequency band for generating a frequency up converted pulse shaped waveform based on a sampling frequency and a symbol rate.

The digital to analog converter 110 is configured to generate a reference analog signal (St) by converting the frequency up converted pulse shaped waveform in digital domain to analog domain. The driver 112 is configured to drive an output load.

The human body 114 acts as a conductive medium to carry the data from the transmitter 116 to the receiver 112 via the human body communication (HBC) network using Electro quasistatic signals. HBC relies on the use of Electro Quasistatic (EQS) fields for communication. EQS fields are non-radiative and hence keep the signal physically confined to the body, providing more physical security from hackers as well as higher energy efficiency per bit of communication.

The transmitter 116 may include one of a switched capacitor network to drive a capacitive load using a plurality of clock phases to clock the switched capacitor network. In another embodiment, the transmitter 116 may include an adiabatic driver to drive a capacitive load using a plurality of clock phases and a plurality of switches. In yet another embodiment, the transmitter 116 may include a class AB amplifier to drive a high capacitive load preceded by a low power DAC to create the pulse shaped waveform.

In an embodiment, the transmitter 116 is capable of pulse shaping input symbols to be transmitted into a bandlimited waveform suitable for transmission by electrically coupling the signal to the said conductive medium 114 in a manner that the components of signal being radiated from said conductive medium 114 conform to regulatory field limits.

In an embodiment, the receiver 118 is capable of reception of pulse shaped signals electrically coupled to the human body 114 and decoding the symbols sent by the transmitter 116 without any ISI. The receiver's filter's impulse response when convolved with the impulse response of transmitter's pulse shaping module follows Nyquist ISI free criteria. The receiver 118 uses a plurality of cascaded integrate and dump filters, each having an independent reset time or each resetting after Ts (symbol duration). The receiver's filter's impulse response has a finite length of Ts (symbol duration).

Alternatively, the receiver 118 uses a single integrate and dump filter, resetting after Ts (symbol duration). The impulse response receiver's filter is given as:

$$P {S}_{R x} ( t ) = \prod ( \frac{t}{{T}_{s}} - \frac{1}{2} ) \qquad equation ( 4 )$$

Where Ts is the symbol duration & II (t) is the rectangular function given as

$$\prod ( t ) = \{ \begin{matrix}1 & ∀ \vert t \vert < 0.5 \\ 0.5 & ∀ \vert t \vert = 0.5 \\ 0 & ∀ \vert t \vert > 0.5\end{matrix} . \qquad equation ( 5 )$$

Though few components and subsystems are disclosed in FIG. 1, there may be additional components and subsystems which are not shown, such as, but not limited to, ports, routers, repeaters, firewall devices, network devices, databases, network attached storage devices, user devices, additional processing systems, servers, assets, machineries, instruments, facility equipment, any other devices, and combination thereof. The person skilled in the art should not be limiting the components/subsystems shown in FIG. 1. Although FIG. 1, illustrates the system 100, is connected to one driver 112, one skilled in the art may envision that the system 100, may be connected to several receivers 118 and drivers, located at same/different locations.

Those of ordinary skilled in the art will appreciate that the hardware depicted in FIG. 1, may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 100 as is unique to the present disclosure or necessary for an understanding of the present disclosure is depicted and described. The remainder of the construction and operation of the system 100 may conform to any of the various current implementations and practices that were known in the art.

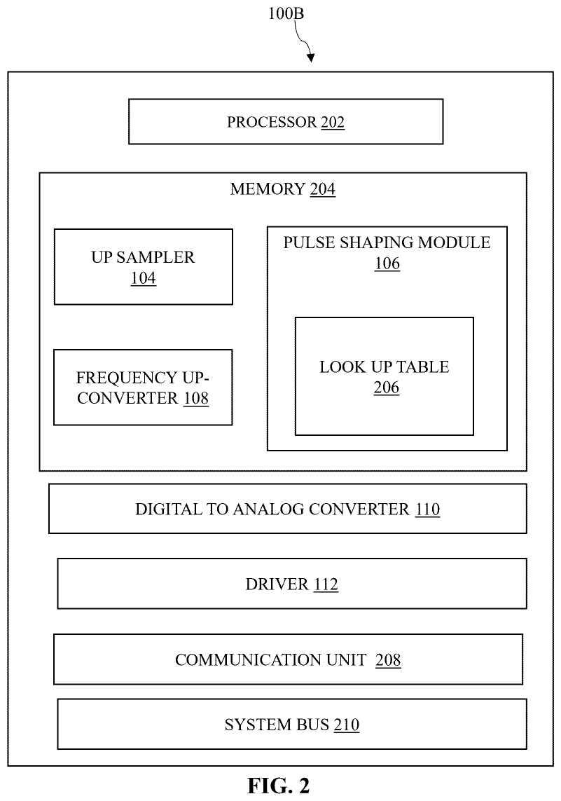

FIG. 2 illustrates an exemplary block diagram representation depicting a detailed view the communication system 100 comprising a plurality of components capable of pulse shaping baseband symbols and into bandlimited waveforms and performing frequency translation on the said bandlimited waveform for Human Body Communication (HBC) networks, according to an example embodiment of the present disclosure. The communication system 100 includes one or more hardware processors 202, a memory 204, a digital to analog converter 110, a driver 112, and a system bus 210. The one or more hardware processors 202, the memory 204, the digital to analog converter 110, the driver 112, are communicatively coupled through the system bus 210 or any similar mechanism. The memory 204 comprises the plurality of modules 110 in the form of programmable instructions executable by the one or more hardware processors 202. Further, the plurality of modules 110 includes an up sampler and a pulse shaping module 106, and a frequency up conversion module 108. In some embodiments, the system 100 may include a separate up sampler unit and a separate pulse shaping module for performing their defined tasks. In some alternate embodiments, the pulse shaping module and the frequency up conversion module 108 may be combined into a single component.

The one or more hardware processors 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the one or more hardware processors 202, such as being a computer-readable storage medium. The one or more hardware processors 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes the plurality of modules stored in the form of machine-readable instructions on any of the above-mentioned storage media and may be in communication with and executed by the one or more hardware processors 202.

The storage unit may be a cloud storage or a local file directory within a remote server.

In an embodiment, the up sampler 102 is configured to up-sample baseband symbols in digital domain for generating an up-sampled baseband symbols based on a pulse shaping filter length and samples per symbol.

The pulse shaping module 106 is configured to pulse shape the up sampled baseband symbols in the digital domain to generate pulse shaped symbols to be transmitted as a bandlimited waveform based on spectral mask requirements. Further, the frequency up conversion unit/module 108 is configured to up-convert a frequency of the pulse shaped symbols in digital domain to a desired frequency band for generating a frequency up converted pulse shaped waveform based on a sampling frequency and a symbol rate. The frequency up converted pulse shaped waveform is transmitted as a passband signal, and wherein the passband signal is electrically coupled to a conductive medium 114 (such as for example a human body) in a manner that the components of the passband signal being radiated from the conductive medium 114 conform to regulatory field limits, and wherein the conductive medium 114 transmits the passband signal to a receiver using a human body as a communication channel/media.

The digital to analog converter 110 is configured to generate a reference analog signal (St) by converting the frequency up converted pulse shaped waveform in digital domain to analog domain. The driver 112 is configured to transmit the generated reference analog signal to a receiver system using a human body communication network.

The communication module 208 is configured to communicate the generated reference analog signal with a receiver system via the driver 112 capable of coupling signals to human body 114.

Though few components and subsystems are disclosed in FIG. 2, there may be additional components and subsystems which is not shown, such as, but not limited to, ports, routers, repeaters, firewall devices, network devices, databases, network attached storage devices, user devices, additional processing systems, servers, assets, machineries, instruments, facility equipment, any other devices, and combination thereof. The person skilled in the art should not be limiting the components/subsystems shown in FIG. 2. Although FIG. 2 illustrates the system 100, is connected to the driver 112 or receiver or any external system (not shown), one skilled in the art may envision that the system 100, may be connected to several driver 112 or receiver or any external system (not shown), located at same/different locations.

Those of ordinary skilled in the art will appreciate that the hardware depicted in FIG. 2 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 100 as is unique to the present disclosure or necessary for an understanding of the present disclosure is depicted and described. The remainder of the construction and operation of the system 100 may conform to any of the various current implementations and practices that were known in the art.

FIG. 3A-B illustrates exemplary block diagram representations of a pulse shaping module 106 and a frequency up conversion module 108, such as those shown in FIG. 2, capable of pulse shaping and up-converting the pulse shaped symbols, according to an example embodiment of the present disclosure.

The pulse shaping module 106 comprises a plurality of data buffers 302 of an arbitrary length configured to store baseband symbols. The pulse shaping module 106 comprises a binary counter 304 of arbitrary size configured to generate a counter values corresponding to look up table (LUT) entries, wherein the counter values comprise timing information to select an appropriate LUT entry pre-stored in a plurality of LUTs 306 based on the baseband symbols. Further, the pulse shaping module 106 comprises a plurality of LUTs 306 coupled to the plurality of data buffers 302 and the binary counter 304. Further, the pulse shaping module 106 comprises a plurality of adders 308 coupled to output of the plurality of LUTs 306, wherein the plurality of adders 308 is configured to sum the output of the plurality of LUTs 306 and feed the adder output to the digital to analog converter (DAC) 110.

In another example embodiment, one or more processors generate a plurality of pre-calculated values representing a desired pulse shape. Further, the plurality of LUTs 306 are configured to store the plurality of pre-calculated values. Furthermore, the plurality of LUTs 306 are configured such that the contents of the LUT can be accessed using a combination of the input data stream and a counter value. The counter value and the input data stream form an address for retrieving the corresponding pre-calculated values, which happen to be the up-sampled and pulse shaped version of the input data stream. The LUT values may hold values corresponding to an arbitrary modulation scheme including but not limited to Quadrature Amplitude Modulation (MQAM), M-ary Phase Shift Keying (MPSK) and amplitude modulation (AM).

In one example embodiment, to generate the frequency up-converted pulse shaped signal, one or more processors configure at least one of the plurality of LUTs with precomputed entries which allow the LUT to output frequency translated and pulse shaped signal signal corresponding to the input data stream, when the selected carrier frequency used for frequency up-conversion is an integer multiple of the symbol rate. If the selected carrier frequency is not an integer multiple of the symbol rate, then one or more processors to configure at least one of the plurality of LUTs for pulse shaping to generate pulse shaped signal while configuring at least or more LUTs 302 to hold sampled carrier signal, and multiply the outputs arising from the said LUTs 302, on a sample by sample basis, to generate the frequency up-converted pulse shaped signal suitable for bandlimited transmission

In one example embodiment, to generate the frequency up converted pulse shaped signal based on the sampling frequency and the symbol rate, the one or more processors 202 is configured to determine whether a carrier frequency (Fcarrier) is an integer multiple of the symbol rate (Fsymbol rate). Further, the one or more processors 202 is configured to store a product of pre-calculated pulse-shaped symbols with a carrier waveform in the plurality of LUTs, if the carrier frequency (Fcarrier) is the integer multiple of the symbol rate (Fsymbol rate). Furthermore, the one or more processors 202 is configured to sample the carrier waveform at a predefined sample rate and store the carrier waveform in the plurality of LUTs 304 and multiply the sampled carrier waveform, sample by sample with the pulse-shaped sample obtained from another set of LUTs, if the carrier frequency (Fcarrier) is not the integer multiple of the symbol rate (Fsymbol rate). Additionally, the one or more processors is configured to generate the frequency up converted pulse shaped signal based on the pre-computed values stored in the plurality of LUTs 302. In an example embodiment, the interpolation, pulse shaping and frequency translation of input data is implemented using a LUT based system 300 comprising of but not limited to, a plurality of data FIFOs 302 of arbitrary length, a binary counter 304 of arbitrary size, a DAC 110 of arbitrary resolution, a plurality of full adders 308 coupled to the DAC 110, a plurality of LUTs 306 coupled with input data FIFO 302, the binary counter 304 and the full adders 308. The output waveform uses an arbitrary modulation scheme, such as for example, but not limited to, Quadrature Amplitude Modulation (MQAM), a M-ary Phase Shift Keying (MPSK), an amplitude modulation (AM) and the like. In one example embodiment, the modulation used may be, for example, a QPSK comprising of but not limited to, at least 2 data FIFOs 302 of arbitrary length, a binary counter 304 of arbitrary size, a DAC 110 of arbitrary resolution, a full adder 308 coupled to the DAC 110, at least two LUTs 306 coupled with input data FIFO 302, the binary counter 304 and the full adder 308.

In some example embodiments using modulation to the likes of QAM or QPSK, the LUT 306 is populated with precomputed values of interpolated, pulse shaped, and frequency translated for combinations of input symbols from data FIFO 302 and counter value 304 for each of I and Q channels.

In another example embodiment, where example modulation used is BPSK, then at least one data FIFOs 302 of arbitrary length, a binary counter 304 of arbitrary size, a DAC 110 of arbitrary resolution, at least one LUT 306 coupled with input data FIFO 302, and the binary counter 304. The LUT 306 is populated with precomputed values of interpolated, pulse shaped, and frequency translated for combinations of input symbols from data FIFO 302 and counter value.

In an example embodiment, the system 100 performs broadband transmission comprising of but not limited to, 1 data FIFOs 302 of arbitrary length, a binary counter 304 of arbitrary size, a DAC 110 of arbitrary resolution, 1 LUTs 306 coupled with input data FIFO, and the binary counter 304. The LUT 306 is populated with precomputed values of interpolated and pulse shaped for combinations of input symbols from data FIFO and counter value.

The pulse shaping module 106 depicts one such realization involving the aforesaid mentioned components to interpolate, pulse shape and mix (frequency translation) the baseband signal to be transmitted over an HBC link. The signal to be transmitted is stored in the FIFO bank 302 consisting of a plurality of FIFOs to enable simultaneous transmission of multiple symbols. The output from these symbols forms the inputs to the bank of LUTs 306 along with the output from the bank of counters 306. Based on the values of FIFO's output 302 and counter's output 304, the LUT bank 306 outputs its values which is added by a bank of adders 308 and passed to the reference DAC 110.

The LUT 306 stores precalculated digital values corresponding to the FIFO 302 and Counter's 304 outputs to mimic the combined operation of a traditional digital filter used for pulse shaping and a mixer for frequency translation. The DAC 110 converts digital bits from the adder 308 into a continuous real valued analog signal which is then used by the driver 112 as reference to drive the output load.

There are many implementations of pulse shaping filter for radio wave based wireless communications transceivers. The need for a transient suppression mechanism arises due to the use words (made from multiple bits) to look up the values as opposed to the bit wise approach suggested in the present invention. The present invention does not cause any unwanted transients, removing the need for any suppression algorithm, making it more power efficient.

In the present system 100, deals directly with the bits and does not require separate paths to pulse shape.

Typical radio wave transmitters also pulse shape the baseband and then use a discrete mixer and multiple phases of carrier for frequency translation, which results in high power consumption. The framework of present system 100 also provides an efficient way of frequency translation without needing a discrete mixer or multiple phases of carrier, making the transmitter very low power.

Further, the framework of present system 100 incorporates a way to mix or perform frequency translation to both in and quadrature phases and output the sum as a single output, removing many power-hungry blocks required in the above patent to make it transmission worthy. One realization of such a system for QPSK modulation is presented in FIG. 3B. FIG. 3B also illustrates a spectrum of signals in the proposed implementation to drive home the point of deriving a band limited signal from bitstream.

The system depicted in FIG. 3B is a special realization of the proposed, wherein the FIFO bank 302 has 2 FIFOs, one for In-phase (I) bits and one for Quadrature (Q) bits. There are two corresponding LUTs 306A-B for I and Q streams which share a common digital counter. PSD_Ib & PSD_Qb show the power spectral density of I and Q baseband symbol streams respectively, which are not suitable for transmission due to band-unlimited nature. The bit stream and the digital counters 304 both form input to the LUTs 306A-B whose output is pulse shaped and frequency translated version of the input bit stream. The final digital signal Dt, obtained by summing the outputs from the 2 LUTs, forms the input to the reference DAC 110 which produces the reference analog signal (St) for the final output driver 112. The PSD of St shows that it is indeed bandlimited, and frequency translated, making it suitable for transmission over a band limited channel.

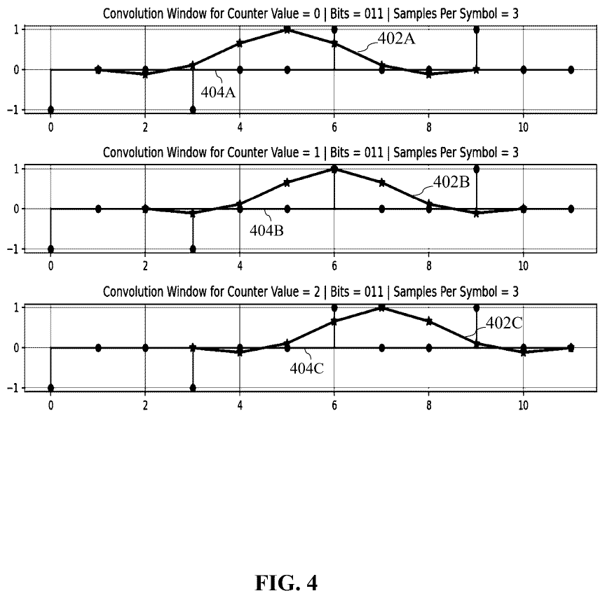

FIG. 4 illustrates an exemplary timing diagram representation of a convolution window between up-sampled baseband symbols and the transmit pulse shaping module for LUT entry computation for pulse shaping, according to an example embodiment of the present disclosure. FIG. 4 depicts how the LUT entries may be computed to achieve pulse shaping for the specific case where samples per symbol (sps) is 3, and bit sequence of concern is 011. The up-sampled pulse train obtained from baseband bits is depicted in the figure, here a baseband bit 0 translates into a −1 followed by sps-1 0s and a baseband bit 1 is represented by 1 followed by sps-1 0s. The pulse shaping filter's impulse response spreads over 3 symbols, hence the LUT's input from data FIFO is 3 bits deep. Since the sps is also 3, the counter values range from 0 to 2, the convolution window for each is shown in the figure. The 3 (sps) LUT entries for given bit sequence 011 are derived by multiplying the curve 402A with the curve 404A and adding all the values of the so obtained product (convolution).

This way LUT entries may be found for 8 possible bit sequences, each sequence further having 3 (sps) entries. This allows the pulse shaping to happen for any sequence of bits by combination of these 8 LUT sequences. The frequency translation or mixing with a carrier whose frequency is an integral multiple of symbol rate may also be added very easily to this example by simply multiplying the values obtained from convolution with the sampled carrier and storing them as entries of the LUT instead of the convolution values.

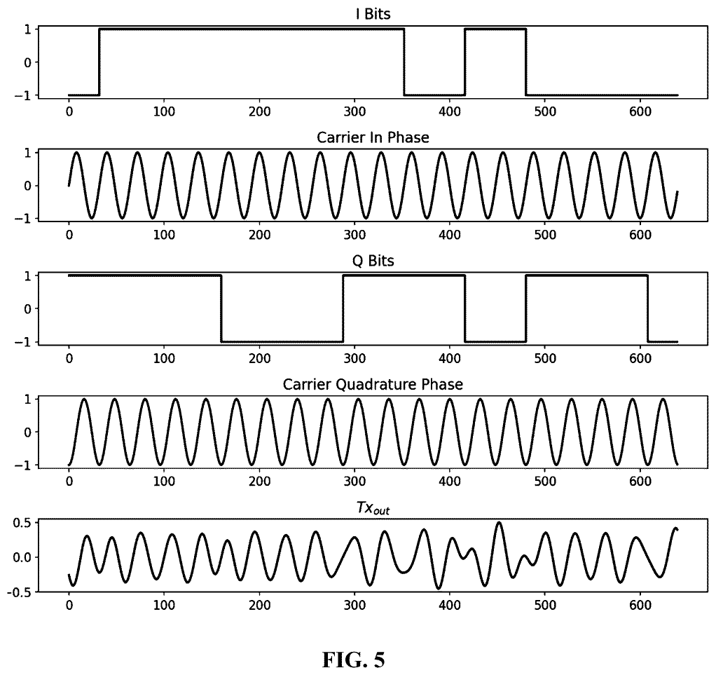

FIG. 5 illustrates an exemplary timing diagram representation of transients of I & Q baseband symbols, I & Q carrier and the output of interpolation, pulse shaping and mixing of I & Q baseband symbols with carrier for QPSK modulation for transmission over band limited channel, according to an example embodiment of the present disclosure;

FIG. 6 illustrates a time domain impulse response of the transmit pulse shape filter and, the corresponding receiver's filter's impulse response and the resulting effective Nyquist pulse, according to an example embodiment of the present disclosure.

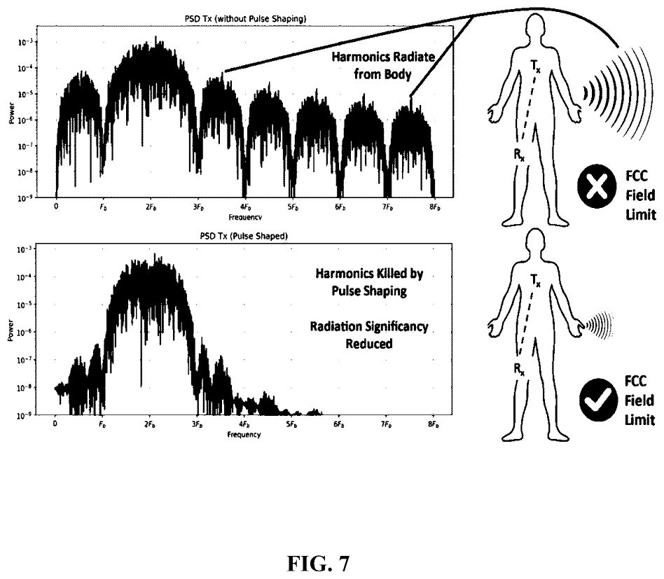

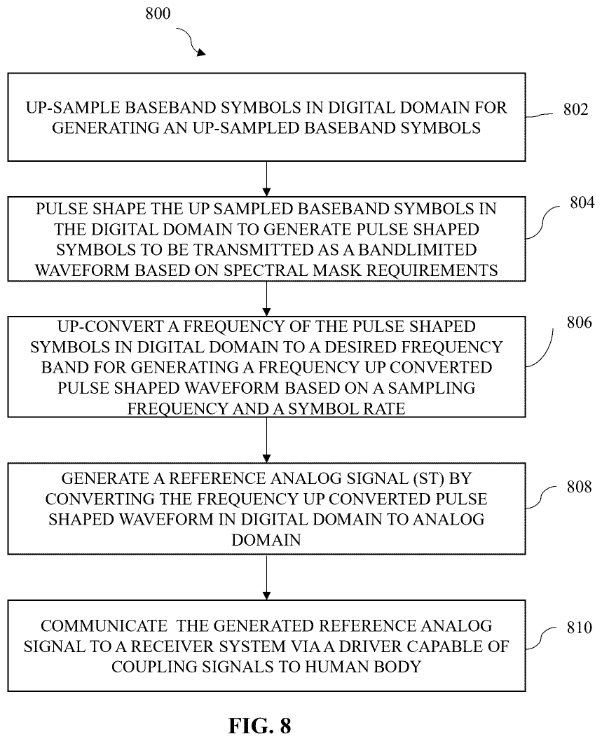

FIG. 7 illustrates a graphical representation of a Power Spectral Density of transmitter's output with and without pulse shaping, according to an example embodiment of the present disclosure. FIG. 7 shows the zoomed version of the spectrum of pulse shaped vs non pulse shaped frequency translated baseband I & Q bits. The effect of pulse shaping is evident on the frequency spectrum, showing that the pulse shaping eliminates the high frequency component from the transmit signal, which would have radiated from the body and violate the field limits set by relevant regulatory authorities. Thus, the transmitter 116 may be qualified as an unintentional radiator when pulse shaping is used.

FIG. 8 illustrates an exemplary flow chart representation of a method for pulse shaping baseband signals in Human Body Communication (HBC) networks, according to an example embodiment of the present disclosure.

At step 802, baseband symbols are up sampled in digital domain for generating an up-sampled baseband symbols. At step 804, the up-sampled baseband symbols are pulse shaped in the digital domain to generate pulse shaped symbols to be transmitted as a bandlimited waveform based on spectral mask requirements. At step 806, the frequency of the pulse shaped symbols in digital domain is up converted to a desired frequency band for generating a frequency up converted pulse shaped waveform based on a sampling frequency and a symbol rate. At step 808, a reference analog signal (St) is generated by converting the frequency up-converted pulse shaped waveform in digital domain to analog domain. At step 810, the generated reference analog signal is communicated to a receiver system via a driver capable of coupling signals to a human body.

The method 800 may be implemented in any suitable hardware, software, firmware, or combination thereof. The order in which the method 800 is described is not intended to be construed as a limitation, and any number of the described method blocks may be combined or otherwise performed in any order to implement the method 800 or an alternate method. Additionally, individual blocks may be deleted from the method 800 without departing from the spirit and scope of the present disclosure described herein. Furthermore, the method 800 may be implemented in any suitable hardware, software, firmware, or a combination thereof, that exists in the related art or that is later developed. The method 800 describes, without limitation, the implementation of the system 100. A person of skill in the art will understand that method 800 may be modified appropriately for implementation in various manners without departing from the scope and spirit of the disclosure.

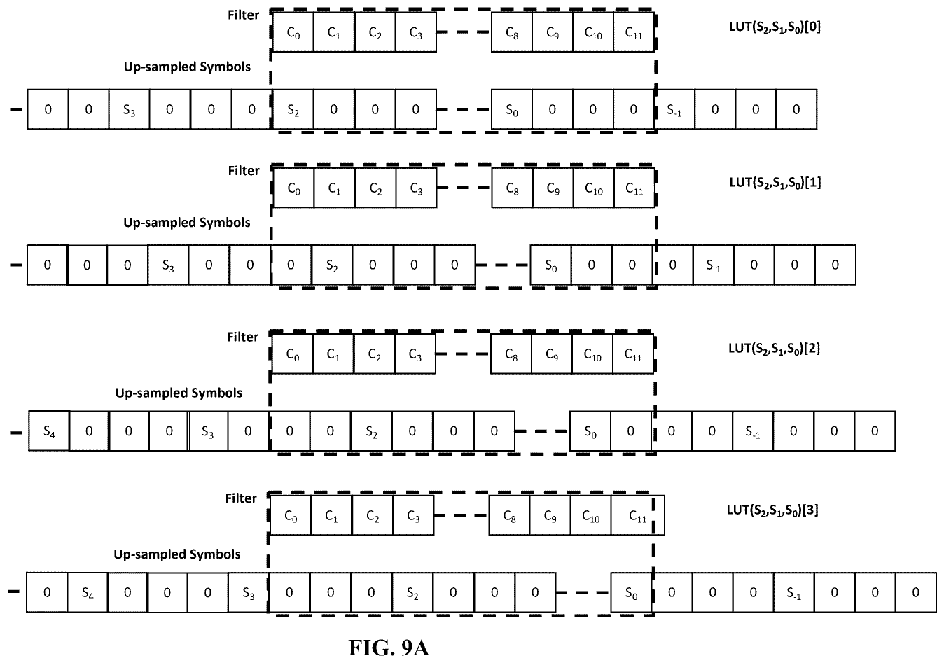

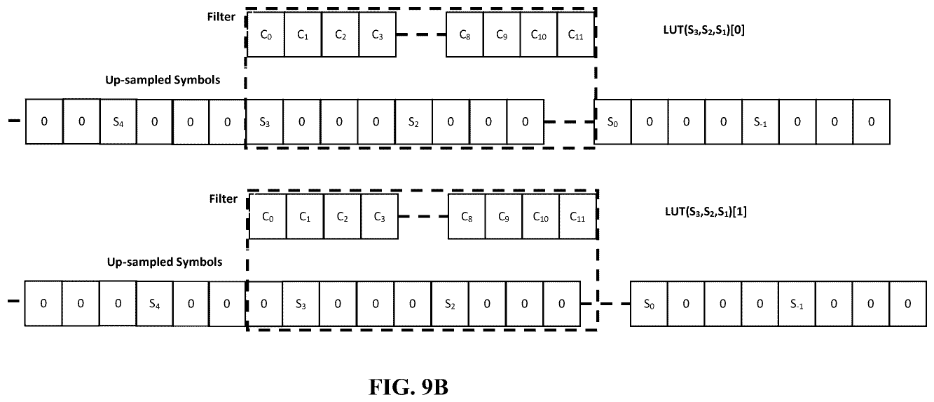

FIGS. 9A-B illustrates an exemplary LUT storing and generating process, according to an example embodiment of the present disclosure. In an embodiment, samples per symbol refers to the number of samples taken per symbol. A symbol is a transmission entity that is derived from one or more bits. For Example: If we consider logic/bit 0 to correspond to a symbol of −1, and logic/bit 1 to correspond to a symbol of 1, then for each bit transmitted, a corresponding symbol (−1 or 1) is sent. PSL (pulse shaping length or filter length) refers to the length of the pulse shaping module in terms of the number of symbols it spans. For Example: If PSL is 3 and SPS (Samples per Symbol) is 4, the filter length would be 4*3=12 samples long. In an embodiment, the input data stream consists of a series of 1's and −1's (representing logic 1 and 0, respectively). When up-sampled by SPS, each symbol in the stream will be followed by SPS-1 zeroes and 1 Symbol, and then the symbol itself.

Since the output of the pulse shaping module 106 only depends on the PSL number of symbols, a Look-Up Table (LUT) 306 with PSL number of select lines may capture all possible outputs. For each possible sequence of PSL symbols, the LUT 306 will store the output of the module 106, which has a length of SPS samples. In one example, the LUT specifics for the example may include a specific LUT size. For a PSL of 3 and SPS of 4 and given that each symbol may be either −1 or 1 (binary case), there will be 2³×4, 2³ rows in the LUT.

Each row corresponds to one combination of 3 bits (b2, b1, b0), and will contain 4 entries, representing the output of the module 106 for each bit sequence. Each row of the LUT is represented with a 3-bit tuple→ (b2, b1, b0).

A counter running from 0 to SPS-1 is used to access the LUT entries. For example, the Kth output of the module 106 is obtained from the LUT as LUT (b2, b1, b0) [K].

The entries in each row of the LUT are independent. Therefore, the output for the entire bitstream may be formed by combining the outputs from the appropriate rows of the LUT, depending on the current bit sequence.

The FIG. 9A illustrates how the LUT is used to generate the filtered output for different bit sequences, showing the combination of LUT entries and the role of the counter in generating the final output.

FIG. 9B depicts an LUT Generation for example SPS=4, a PSL=3, in accordance with an embodiment of the present disclosure. The system discloses a method of storing symbols that have undergone pulse shaping and frequency up conversion. This is particularly useful when working with digital communication systems, where the signal must be prepared for transmission at a specific carrier frequency. Earlier, the method for storing pulse-shaped symbols was discussed. This involves the creation of a Look-Up Table (LUT) that stores the output of a pulse shaping module 106 for various bit sequences. This LUT approach helps in efficiently generating the necessary signal for transmission.

In an embodiment, a condition for storing frequency up-converted symbols include, determining if the carrier frequency is an integer multiple of the symbol rate, then it becomes feasible to store the frequency upconverted symbols directly in the LUT. This is advantageous because it simplifies the process and reduces the need for additional real-time computation during signal generation. For Example: Consider a case where the carrier frequency F_{carrier}=20 Mhz, and the symbol rate F_{symbol rate}=10MSymb/s. Since 20 MHz is an integer multiple of 10 MSymbols/s, the condition is satisfied. When the above condition is met, it ensures that the LUT signal remains continuous across all bitstreams. This continuity is crucial for maintaining signal integrity and avoiding abrupt transitions that could lead to distortion or other transmission issues.

In case, when condition is not met, that is, If the condition where the carrier frequency is an integer multiple of the symbol rate may not be met, frequency up conversion may still be achieved. In such cases, the pulse shaped signal output from the LUT may be multiplied by a sampled carrier on a sample-by-sample basis. For very high carrier frequencies, this frequency up conversion may also be handled in the analog domain. However, the proposed digital mixing method (either within the LUT or after the LUT output) is generally more power-efficient, especially for wideband transmissions like those used in Wi-R.

The computational resources needed for a module 106 with a length of PSL multiplied by SPS consist of multipliers and adders. Specifically, the module 106 requires half the product of PSL and SPS multipliers, and slightly more than half the product of PSL and SPS adders.

In an example, for a filter of length PSL*SPS, the required resources are as follows:

(PSL*SPS/2), multipliers and (PSL*SPS/2)+ log 2 ((PSL*SPS/2)) adders are required.

This particularly explains the method for storing pulse-shaped frequency upconverted symbols and the associated benefits in digital communication systems.

The present invention has many advantages, namely first ever pulse shaping system proposed for communication by electrically coupling signals to the human body (Human Body Communication). The present pulse shaping methods ensure bandlimited ISI free communication. Band-limiting transmitter's output ensures EM radiation limits set by relevant authorities for unintentional radiators is not violated. The class of proposed pulse shaping module 106 (also referred herein as module 106) have finite impulse response, unlike traditional pulse shaping module which need to be truncated. The receiver's filter's design for ISI free reception of signals shaped using proposed class of pulse shapes may be readily implemented in mixed signal form, without requiring any digital signal processing (DSP) of any kind, leading to simpler and power efficient receivers.

The present method of implementing the interpolation, pulse shaping and frequency up-conversion using LUTs leads to simpler Tx designs without the need for discrete FIR filter or DSP or mixers of any sort, which saves on design complexity and power for transmitters.

The present method of using LUT based pulse shaping and frequency translation also provides the ability to handle multiple bit streams simultaneously with efficient hardware scaling. Unlike previous LUT based system, the present system provides a simpler, more efficient, and complete system, without creating any unwanted transients.

A method of band limiting transmit signals for systems utilizing electro-quasistatic signals to communicate via conductive medium using class of pulse shaping functions is disclosed. A class of receiver's impulse responses allowing inter-symbol interference (ISI) free reception of pulse shaped transmit signal is also disclosed. The generalized system comprises of, but not limited to, a plurality of LUTs, data FIFOs, adders, a counter & a DAC to up-sample, pulse shape & frequency translate input baseband symbols for bandlimited transmission employing arbitrary modulation scheme. The LUT stores precalculated N-bit digital samples, the counter's output & data FIFOs' outputs form the select line for the LUT. The adders digitally sum output from the plurality of LUTs and feed it to the DAC for final transmission. Specific realizations of the generalized system for BPSK and QPSK are disclosed. Adaption of the generalized system for pulse shaped baseband transmission is disclosed.

In one example embodiment, an HBC receiver 118 that receives the signal directly from the human body employs a differential low-noise amplifier (LNA) to cancel the interference on the signal is disclosed. The HBC receiver 118 may include one input which is connected to the electrode that captures the signal from the body and the other input is grounded with specific termination and a second input which is connected to the floating electrode with respect to that the signal from the body is referenced. The floating electrode, which is connected to the battery negative terminal, which is available on the PCB, with specific termination. The specific termination is resistive if the impedance of body and signal electrode is low. The specific termination is capacitive if the impedance of body and signal electrode is high. The inputs of differential LNA have long PCB traces to the body electrodes that capture the interference from surroundings of body or from aggressors present on the PCB on both inputs. The input traces of differential LNA in PCB are designed parallelly. The input traces of differential LNA in PCB capture similar interference which may be cancelled by the differential nature of the LNA.

The HBC receiver 118 receives the signal directly from the human body 114 employs a differential low-noise amplifier (LNA) to reject the supply and ground noise.

The differential LNA utilizes floating ground whose potential is modulated with ambient interference which causes ground bounces unlike conventional LNAs. The differential LNA utilizes high impedance bottom current source to minimize the effect of ground noise and bounces. The ground noise is rejected with rejection ratio of >10 dB (example design >60 dB) in differential output. The differential LNA has very sensitive power supply as it is referenced to the floating ground which causes bounces on the supply line, rejects the supply bounces simultaneously with ground bounces. The HBC utilizes high impedance top current source to minimize the effect of supply noise and bounces. The supply noise is rejected with rejection ratio of >10 dB (example design >50 dB) in differential output.

The system 100 may be a hardware device including the hardware processor executing machine-readable program instructions. Execution of the machine-readable program instructions by the hardware processor may enable the system 100 to convert the direct analog samples to compressed digitized samples. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The hardware processor(s) may include, but are not limited to, microprocessors, microcomputers, microcontrollers, digital signal processors, central processing units, state machines, logic circuits, and/or any devices that manipulate data or signals based on operational instructions, and the like. Among other capabilities, the hardware processor may fetch and execute computer-readable instructions in the memory operationally coupled with the system 100 for performing tasks such as data processing, input/output processing, and/or any other functions. Any reference to a task in the present disclosure may refer to an operation being or that may be performed on data.

One of the ordinary skill in the art will appreciate that techniques consistent with the present disclosure are applicable in other contexts as well without departing from the scope of the disclosure.

What has been described and illustrated herein are examples of the present disclosure. The terms, descriptions, and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein may comprise hardware and software elements. The embodiments that are implemented in software include but are not limited to, firmware, resident software, microcode, a. The functions performed by various modules described herein may be implemented in other modules or combinations of other modules. For the purposes of this description, a computer-usable or computer-readable medium may be any apparatus that may comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries may be defined so long as the specified functions and relationships thereof are appropriately performed. Alternatives (including equivalents, extensions, variations, deviations, and the like, of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a”, “an”, and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limited, of the scope of the invention, which is outlined in the following claims.

What is claimed is:

1. A system for pulse shaping of baseband signals in communication networks using electro-quasistatic signals, the system comprising:
one or more hardware processors; and
a memory coupled to the one or more hardware processors, wherein the memory comprises a plurality of modules in the form of programmable instructions executable by the one or more hardware processors, wherein the plurality of modules comprise:
an up-sampling module configured to:
up-sample baseband symbols in digital domain for generating up-sampled baseband symbols;
a pulse shaping module configured to pulse shape the up sampled baseband symbols in the digital domain to generate pulse shaped symbols to be transmitted as a bandlimited waveform based on spectral mask requirements;
a frequency up conversion module configured to:
up-convert a frequency of the pulse shaped baseband symbols in digital domain to a desired frequency band for generating a frequency up converted pulse shaped waveform based on a sampling frequency and a symbol rate;
a digital to analog converter configured to generate a reference analog signal (St) by converting the frequency up converted pulse shaped waveform in digital domain to analog domain; and
a communication module configured to communicate the generated reference analog signal to a receiver system via a driver capable of coupling signals to a human body.

2. The communication system of claim 1, wherein the frequency up converted pulse shaped waveform is transmitted as a passband signal which is electrically coupled to the human body in a manner that the components of the passband signal being radiated from the human body conform to regulatory field limit.

3. The communication system of claim 1, wherein the pulse shaping module comprises:
a plurality of data buffers of an arbitrary length configured to store the baseband symbols;
a binary counter of arbitrary size configured to generate a counter values corresponding to look up table (LUT) entries, wherein the counter values comprise timing information to select an appropriate LUT entry pre-computed in a plurality of LUTs based on the baseband symbols;
a plurality of LUTs coupled to the plurality of data buffers and the binary counter; and
a plurality of adders coupled to output of the plurality of LUTs, wherein the plurality of adders is configured to sum the output of the plurality of LUTs and feed the adder output to the digital to analog converter (DAC).

4. The communication system of claim 1, wherein the one or more processors is configured to:
generate a plurality of pre-calculated values representing a desired pulse shape;
store the plurality of pre-calculated values in a look-up table (LUT);
access the look-up table using a combination of the input data stream and a counter value to retrieve a corresponding pre-calculated value, wherein the counter value and the input data stream form an address for retrieving the corresponding pre-calculated value;
output the retrieved pre-calculated value as a pulse-shaped sample; and
up-convert the frequency of the pulse shaped sample in digital domain to a desired frequency band for generating the frequency up converted pulse shaped signal based on the sampling frequency and the symbol rate.

5. The communication system of claim 1, to generate the frequency up-converted pulse shaped samples in digital domain, the one or more processors is configured to:
determine whether a carrier frequency is an integer multiple of the symbol rate;
store a product of pre-calculated pulse-shaped symbols with a carrier waveform in the plurality of LUTs, if the carrier frequency is an integer multiple of the symbol rate;
sample the carrier waveform at a predefined sample rate and store the carrier waveform in the plurality of LUTs and multiply the sampled carrier waveform sample by sample with the pulse-shaped sample obtained from another set of LUTs, if the carrier frequency fails to correspond to the integer multiple of the symbol rate; and
generate the frequency up converted pulse shaped signal based on the pre-computed values stored in the plurality of LUTs.

6. The communication system of claim 1, wherein the pulse shaping module on the transmitter side comprises a filter, wherein the filter comprises a transmitter side impulse response being finite and wherein a first derivative of the transmitter side impulse response being continuous at all points.

7. The communication system of claim 6, wherein the pulse shaping module comprises the filter, wherein the filter is configured to generate the transmitter side impulse response by performing linear operations on at least one of sines, sinc and polynomial expressions in one of a time domain and a frequency domain.

8. The communication system of claim 7, wherein the pulse shaping module comprises the filter, wherein the filter is configured to generate pulses by performing convolution of the transmitter side finite impulse response with one of an arbitrary pulse of finite length of Ts, and a rectangular pulse, wherein the generated pulse upon convolution comply with a Nyquist ISI free communication criteria.

9. The communication system of claim 8, wherein receiver's filter's impulse response when convolved with the impulse response of transmitter's pulse shaping module complies with the Nyquist ISI free communication criteria.

10. The communication system of claim 1, wherein the receiver comprises at least one integrate and dump filter, each having an independent reset time.

11. The communication system of claim 1, wherein the transmitter comprises one of a switched capacitor network to drive a capacitive load using a plurality of clock phases to clock the switched capacitor network.

12. The communication system of claim 1, wherein the transmitter comprises an adiabatic driver to drive a capacitive load using a plurality of clock phases and a plurality of switches.

13. The communication system of claim 1, wherein the transmitter comprises a class AB amplifier to drive a high capacitive load preceded by a low power DAC to create the pulse shaped waveform.

14. A communication method for communication using electro quasistatic signals comprising:
up-sampling, by a processor, baseband symbols in digital domain for generating up-sampled baseband symbols;
pulse shaping, by the processor, the up sampled baseband symbols in the digital domain to generate pulse shaped symbols to be transmitted as a bandlimited waveform based on spectral mask requirements;
up-converting, by the processor, a frequency of the pulse shaped symbols in digital domain to a desired frequency band for generating a frequency up converted pulse shaped waveform based on a sampling frequency and a symbol rate;
generating, by a digital to analog converter, a reference analog signal (St) by converting the frequency up converted pulse shaped waveform in digital domain to analog domain; and
communicating, by a communication module coupled to the processor, the generated reference analog signal to a receiver system via a driver capable of coupling signals to a human body.

15. The communication method of claim 14, wherein the frequency up converted pulse shaped waveform is transmitted as a passband signal, which is electrically coupled to the human body in a manner that the components of the passband signal being radiated from the human body conform to regulatory field limits.

16. The communication method of claim 15, wherein generating the frequency up converted pulse shaped waveform based on the sampling frequency and the symbol rate comprises:
generating, by the processor, a plurality of pre-calculated values representing a desired pulse shape;
storing, by the processor, the plurality of pre-calculated values in a look-up table (LUT);
accessing, by the processor, the look-up table using a combination of the input data stream and a counter value to retrieve a corresponding pre-calculated value, wherein the counter value and the input data stream form an address for retrieving the corresponding pre-calculated value;
outputting, by the processor, the retrieved pre-calculated value as a pulse-shaped sample; and
up-converting, by the processor, the frequency of the pulse shaped sample in digital domain to the desired frequency band for generating the frequency up converted pulse shaped signal based on the sampling frequency and the symbol rate.

17. The communication method of claim 15, wherein generating the frequency up-converted pulse shaped samples in digital domain comprises:
determining, by the processor, whether a carrier frequency (Fcarrier) is an integer multiple of the symbol rate (Fsymbol rate);
storing, by the processor, a product of pre-calculated pulse-shaped symbols with a carrier waveform in a plurality of Look up Tables, if the carrier frequency (Fcarrier) is an integer multiple of the symbol rate (Fsymbol rate);
sampling, by the processor, the carrier waveform at a predefined sample rate and store the carrier waveform in the plurality of LUTs and multiply the sampled carrier waveform sample by sample with the pulse-shaped sample obtained from another set of LUTs, if the carrier frequency (Fcarrier) fails to correspond to the integer multiple of the symbol rate (Fsymbol rate); and
generating, by the processor, the frequency up converted pulse shaped signal based on the pre-computed values stored in the plurality of LUTs.
